(19) United States
(12) Patent Application Publication
(10) Pub. No.: US 2018/0001710 A1
(43) Pub. Date: Jan. 4, 2018

(54) PNEUMATIC TIRE

(71) Applicant: Toyo Tire & Rubber Co., Ltd., Osaka (JP)

(72) Inventor: Tsuyoshi Fujioka, Osaka-shi (JP)

(73) Assignee: Toyo Tire & Rubber Co., Ltd., Osaka (JP)

(21) Appl. No.: 15/616,233

(22) Filed: Jun. 7, 2017

(30) Foreign Application Priority Data
Jun. 30, 2016 (JP) 2016-130527

(51) Int. Cl. B60C 11/12; B60C 11/03; B60C 11/13

(52) U.S. Cl. CPC B60C 11/1236; B60C 11/1353; B60C 11/1204; B60C 11/0309; B60C 2011/1213; B60C 2011/1361

(57) ABSTRACT

A block includes a pair of longitudinal side surface portions facing the main grooves and a pair of lateral side surface portions facing the lateral grooves. The pair of longitudinal side surface portions includes a pair of first longitudinal side surface portions that has ridgelines inclined with respect to the tire circumferential direction, and a pair of second longitudinal side surface portions that has ridgelines shorter than ridgelines of the first longitudinal side surface portions and inclined greater than the ridgelines of the first longitudinal side surface portions. In the shoulder block, notches are provided at a central portion of the pair of first longitudinal side surface portions, a first sipe that is opened to the notches and connects the notches on both sides is provided, and second sipes of which the both ends terminate within the block are provided on both sides of the first sipe.

### CROSS-REFERENCE TO RELATED APPLICATIONS

This application is based upon and claims the benefit of priority from the prior Japanese Patent Application No. 2016-130527, filed on Jun. 30, 2016; the entire contents of which are incorporated herein by reference.

### BACKGROUND

### 1. Field of the Invention

This embodiment relates to a pneumatic tire.

### 2. Related Art

There is a pneumatic tire where block rows are formed at a tread portion by main grooves extending in a tire circumferential direction and lateral grooves intersecting the main grooves. In addition, it is also known to provide sipes in blocks to improve traction properties and to improve running performance on a wet road surface or an ice road surface (see US2014/360639A1, US2001/022209A1, JP-A-2011-000991, and US2003/102064A1).

For example, US2014/360639A1 discloses a pneumatic tire, in which in a block of which both sides are sandwiched between the straight main grooves, notches are provided in a pair of side surface portions facing the main groove, a sipe having one end opened in the notch and the other end terminating in the block is provided, and on both sides in the tire circumferential direction of the sipe, sipes having both ends terminating in the block are provided. JP-A-2011-000991 discloses a pneumatic tire, in which a main sipe crossing a center portion in a tire circumferential direction of a block and sub-sipes having both ends terminating in the block in the tire circumferential direction on both sides of the main sipe are provided. US2001/022209A1 discloses a structure, in which a sipe crossing a center portion in a tire circumferential direction of a block is provided and both ends of the sipe opens to main grooves via notches.

In a tire having a block pattern, it is also required to improve a traction property and uneven wear resistance property, and it is desired that both of them are compatible at a higher level.

### SUMMARY

An object of this embodiment is to provide a pneumatic tire capable of satisfying both a traction property and uneven wear resistance property.

The pneumatic tire according to the embodiment includes a tread portion which is provided with a plurality of main grooves extending in a tire circumferential direction and a plurality of lateral grooves extending in a direction intersecting the main grooves, to form block rows. At least one block row sandwiched between the main grooves includes blocks having the following configuration. That is, the block includes a pair of longitudinal side surface portions facing the main grooves and a pair of lateral side surface portions facing the lateral grooves. The pair of longitudinal side surface portions includes a pair of first longitudinal side surface portions that has ridgelines inclined with respect to the tire circumferential direction, and a pair of second longitudinal side surface portions that has ridgelines shorter than the ridgelines of the first longitudinal side surface portions and inclined greater with respect to the tire circumferential direction than the ridgelines of the first longitudinal side surface portions, and intersects the first longitudinal side surface portions at an obtuse angle. The block includes notches formed at a central portions of the pair of first longitudinal side surface portions, a first sipe that is opened to the notches and connects the notches on both sides, and second sipes formed on both sides of the first sipe in the tire circumferential direction and having both ends thereof terminated within the block.

### BRIEF DESCRIPTION OF THE DRAWINGS

FIG. 1 is a perspective view of a pneumatic tire according to an embodiment (Example 1).

FIG. 2 is partially enlarged perspective view of a tread portion of the same embodiment.

FIG. 3 is a developed view illustrating a tread pattern of the same embodiment.

FIG. 4 is a plan view of a center block of the same embodiment.

FIG. 5 is a plan view of a shoulder block of the same embodiment.

FIG. 6 is a developed view illustrating a tread pattern of Example 2.

FIG. 7 is a developed view illustrating a tread pattern of Example 3.

FIG. 8 is a developed view illustrating a tread pattern of Comparative Example 1.

FIG. 9 is a developed view illustrating a tread pattern of Comparative Example 2.

### DETAILED DESCRIPTION

Hereinafter, embodiments will be described with reference to the drawings.

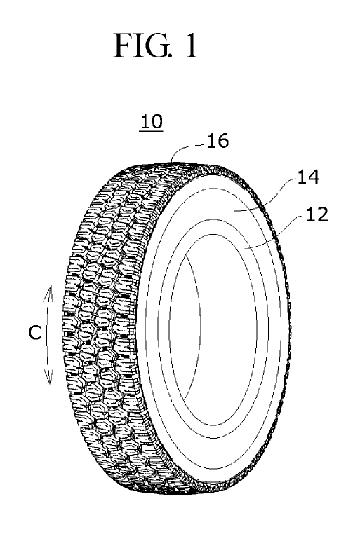

As illustrated in FIG. 1, a pneumatic tire 10 according to an embodiment includes a pair of right and left bead portions 12 and side wall portions 14, and a tread portion 16 that is provided between both side wall portions so as to connect radially outer end portions of the right and left side wall portions 14, and a general tire structure can be adopted for other than a tread pattern.

As illustrated in FIGS. 1 to 3, a plurality of block rows 22 formed by a plurality of main grooves 18 extending in a tire circumferential direction C and a plurality of lateral grooves 20 intersecting the main grooves 18 are provided on a tread rubber surface of the tread portion 16 in a tire width direction W.

In the example, three main grooves 18 are formed at intervals in the tire width direction W. A center main groove 18A positioned on a tire equator CL and a pair of shoulder main grooves 18B and 18B disposed on both sides are provided. Each of the three main grooves 18 is a zigzag groove extending in the tire circumferential direction C while being bent. Moreover, the main groove 18 is a circumferential direction groove having a groove width (opening width) of generally 5 mm or more.

A plurality of land portions partitioned by the main grooves 18 are formed in the tread portion 16. The plurality of lateral grooves 20 are provided at intervals in the tire circumferential direction C. Therefore, each land portion is formed as the block row 22 formed by disposing a plurality of blocks in the tire circumferential direction C. More specifically, a pair of right and left center land portions sandwiched between the center main groove 18A and the shoulder main groove 18B is formed as center block rows 22A formed by disposing a plurality of center blocks 24 in the tire circumferential direction C by providing lateral grooves 20A. The center block row 22A is a block row positioned at a central portion in the tire width direction W in the tread portion 16. In addition, a pair of right and left shoulder land portions sandwiched between the shoulder main groove 18B and a tire ground contact end E is formed as shoulder block rows 22B formed by disposing a plurality of shoulder blocks 26 in the tire circumferential direction C by providing the lateral grooves 20B. The shoulder block rows 22B are block rows positioned at both end portions in the tire width direction in the tread portion 16.

The lateral grooves 20A and 20B are grooves extending in a direction intersecting main grooves 18A and 18B, and crossing each land portion. The lateral grooves 20A and 20B may not necessarily be parallel to the tire width direction W as long as they are grooves extending in the tire width direction W. In the example, the lateral grooves 20A and 20B are grooves extending in the tire width direction W while being inclined.

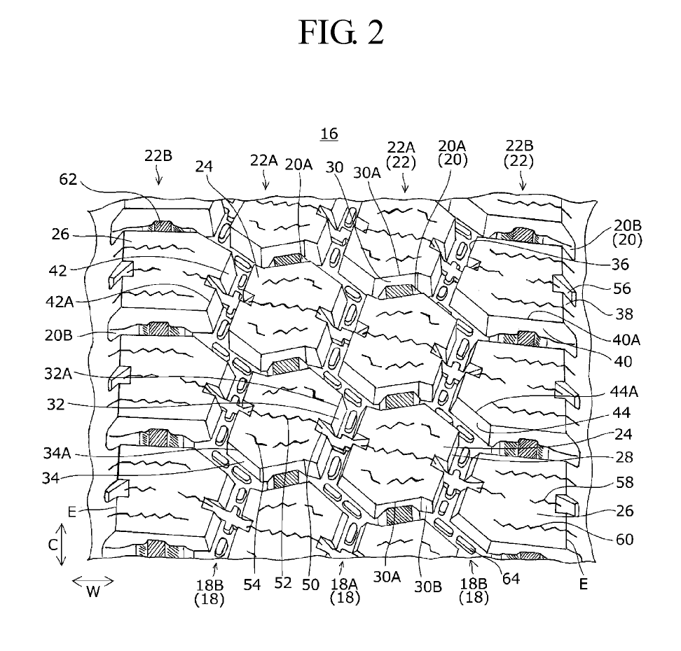

As illustrated in FIGS. 2 to 4, the center block 24 includes a pair of right and left longitudinal side surface portions 28 and 28 facing the right and left main grooves 18A and 18B, and a pair of front and rear lateral side surface portions 30 and 30 facing the front and rear lateral grooves 20A and 20A. Here, the longitudinal side surface portion 28 is a side surface portion facing the main groove 18 (that is, configuring a part of a groove wall surface of the main groove by being in contact with the main groove) out of side surface portions of the block 24. The lateral side surface portion 30 is a side surface portion facing the lateral groove 20 (that is, configuring a part of a groove wall surface of the lateral groove by being in contact with the lateral groove) out of the side surface portions of the block 24.

The pair of longitudinal side surface portions 28 and 28 is formed of a pair of first longitudinal side surface portions 32 and 32 having ridgelines 32A and 32A parallel to each other inclined with respect to the tire circumferential direction C, and a pair of second longitudinal side surface portions 34 and 34 having ridgelines 34A and 34A parallel to each other inclined greater with respect to the tire circumferential direction C than the ridgelines 32A of the first longitudinal side surface portions 32. Here, the ridgeline is a line generated at an intersection between a side surface and an upper surface (tread surface) of a block. The ridgeline 32A of the first longitudinal side surface portion 32 has a linear shape that is inclined to one side at an angle α with respect to the tire circumferential direction C. The ridgeline 34A of the second longitudinal side surface portion 34 has a linear shape that is inclined to another side at an angle β with respect to the tire circumferential direction C. Therefore, the angle β is set greater than the angle α (α<β). As an example, the angle α may be 10° to 30° and the angle β may be 30° to 55°. In addition, the ridgeline 34A of the second longitudinal side surface portion 34 is set shorter than the ridgeline 32A of the first longitudinal side surface portion 32. That is, J1>J2, in which J1 is a length of the ridgeline 32A, and J2 is a length of the ridgeline 34A. Furthermore, the second longitudinal side surface portion 34 is formed so as to intersect the first longitudinal side surface portion 32 at an obtuse angle. That is, an angle θ between the ridgeline 32A of the first longitudinal side surface portion 32 and the ridgeline 34A of the second longitudinal side surface portion 34 is greater than 900 (θ>90°).

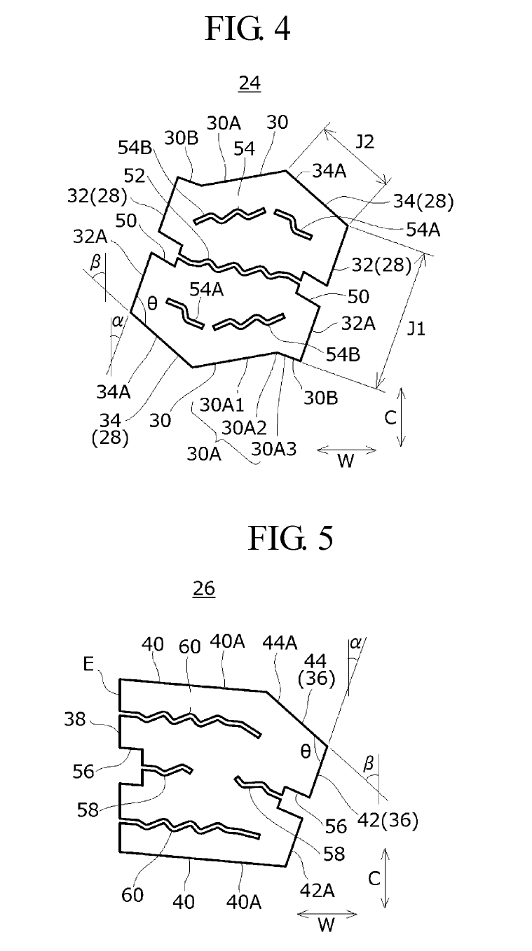

In addition, the pair of lateral side surface portions 30 and 30 is side surface portions having ridgelines 30A and 30A parallel to each other inclined with respect to the tire width direction W. An angle of the ridgeline 30A with respect to the tire width direction W may be, for example, 20° or less. The lateral side surface portion 30 is a side surface portion that is interposed between the first longitudinal side surface portion 32 of one longitudinal side surface portion 28 and the second longitudinal side surface portion 34 of the other longitudinal side surface portion 28, and connects them. As described above, as illustrated in FIG. 4, the center block 24 has a substantially hexagonal shape (convex hexagonal shape) in a plan view.

As illustrated in FIGS. 2, 3, and 5, the shoulder block 26 includes a longitudinal side surface portion 36 facing the shoulder main groove 18B, a longitudinal side surface portion 38 facing the tire ground contact end E, and a pair of front and rear lateral side surface portions 40 and 40 facing the front and rear lateral grooves 20B and 20B. The longitudinal side surface portions 36 and 38 are side surface portion facing the main groove 18 or the ground contact end E (that is, configuring a part of the groove wall surface of the main groove or a ground contact end wall by being in contact with the main groove or the ground contact end) out of the side surface portions of the shoulder block 26. The lateral side surface portion 40 is a side surface portion facing the lateral groove 20B (that is, configuring a part of the groove wall surface of the lateral groove by being in contact with the lateral groove) out of the side surface portions of the shoulder block 26.

Similar to the longitudinal side surface portion 28, the longitudinal side surface portion 36 facing the shoulder main groove 18B is formed of a third longitudinal side surface portion 42 having a ridgeline 42A inclined with respect to the tire circumferential direction C, and a fourth longitudinal side surface portion 44 having a ridgeline 44A inclined greater with respect to the tire circumferential direction C than the ridgeline 42A of the third longitudinal side surface portion 42. The ridgeline 42A of the third longitudinal side surface portion 42 has a linear shape that is inclined to one side at the angle α with respect to the tire circumferential direction C. The ridgeline 44A of the fourth longitudinal side surface portion 44 has a linear shape that is inclined to another side at the angle β with respect to the tire circumferential direction C. The angle β is set greater than the angle α (α<β). In addition, the ridgeline 44A of the fourth longitudinal side surface portion 44 is set shorter than the ridgeline 42A of the third longitudinal side surface portion 42. Furthermore, the fourth longitudinal side surface portion 44 is formed to intersect the third longitudinal side surface portion 42 at an obtuse angle (angle θ between the ridgeline 42A and the ridgeline 44A is greater than 90°).

In addition, the pair of lateral side surface portions 40 and 40 is a side surface portion having ridgelines 40A and 40A parallel to each other inclined with respect to the tire width direction W. An angle of the ridgeline 40A may be, for example, 20° or less with respect to the tire width direction W. As described above, as illustrated in FIG. 5, the shoulder block 26 has a substantially pentagonal shape (convex pentagonal shape) in a plan view.

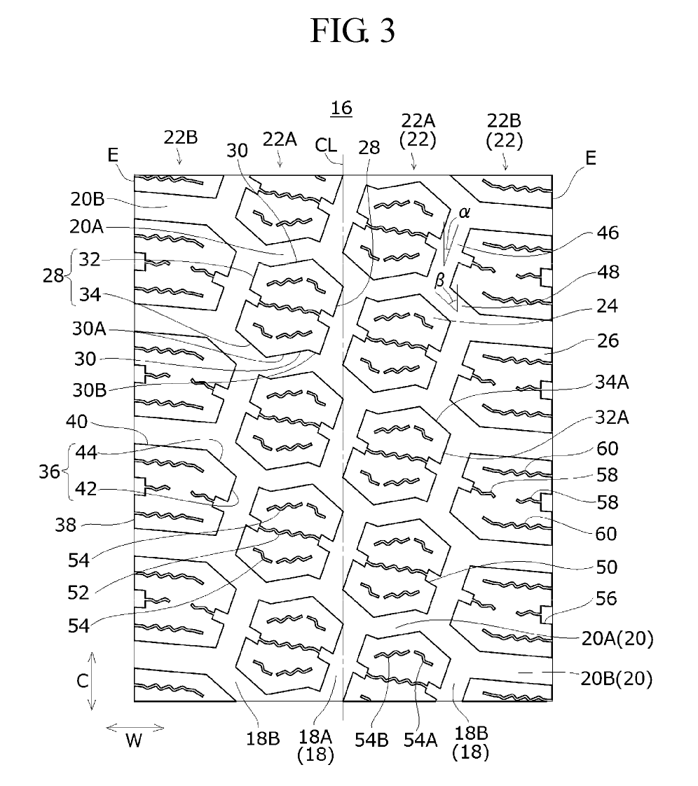

Because of the shapes of the center block 24 and the shoulder block 26 described above, the main groove 18 and the lateral groove 20 are provided as follows. As illustrated in FIG. 3, the main groove 18 has a first groove portion 46 that is inclined to one side at the angle α with respect to the tire circumferential direction C and a second groove portion 48 that is inclined to another side at an angle β with respect to the tire circumferential direction C, which are alternately repeated via an obtuse angle bend portion in the tire circumferential direction C thereby forming a zigzag shape. The second groove portion 48 is shorter than the first groove portion 46 and the inclined angle β with respect to the tire circumferential direction C is set greater than the inclined angle α of the first groove portion 46. Moreover, between adjacent main grooves 18A and 18B, top portions of the bend portions are disposed to face each other, the top portions are connected by the lateral groove 20A, and thereby the center block rows 22A are formed. In addition, the lateral grooves 20B are provided outward of the shoulder main groove 18B in the tire width direction from the top portion of each bend portion to the tire ground contact end E and thereby the shoulder block rows 22B are formed.

In the center block 24, notches 50 and 50 are respectively provided at the central portions of the pair of first longitudinal side surface portions 32 and 32 in the tire circumferential direction C. The notch 50 is a U-shaped recess in a plan view cut out toward a groove bottom of the main groove 18 from a block upper surface to a block bottom portion. The notch 50 is provided at the central portion of the first longitudinal side surface portion 32 in a ridgeline direction, that is, in the vicinity of the center of the ridgeline.

The center block 24 is provided with a first sipe 52 which opens into the notches 50 and connects between the notches 50 and 50 on both sides. The first sipe 52 is a both-end open sipe which extends in the tire width direction W and of which the both ends open into the notches 50 thereby crossing the center block 24 in the tire width direction W.

The center block 24 is further provided with second sipes 54 respectively of which both ends terminate within the block 24 on both sides of the first sipe 52 in the tire circumferential direction. That is, in the center block 24, the second sipes 54, of which the both ends terminate within the block portions, are respectively provided in the block portions on the both sides in the tire circumferential direction partitioned by the first sipe 52. The second sipe 54 is a both-end closed sipe extending in the tire width direction W.

In the example, two second sipes 54 are provided on each of the both sides of the first sipe 52 in the tire circumferential direction. Specifically, the second sipe 54 is formed of one sipe 54A extending parallel to the ridgeline 34A of the second longitudinal side surface portion 34 and one sipe 54B extending parallel to the ridgeline 30A of the lateral side surface portion 30. These two sipes 54A and 54B have lengths different from each other. That is, in the example, the ridgeline 34A of the second longitudinal side surface portion 34 is longer than the ridgeline 30A of the lateral side surface portion 30. Therefore, the length of the sipe 54B provided along the ridgeline 30A of the lateral side surface portion 30 is set greater than the length of the sipe 54A provided along the ridgeline 34A of the second longitudinal side surface portion 34.

The lateral side surface portion 30 of the center block 24 is formed such that one end portion 30B in the tire width direction W protrudes within the lateral groove 20A. In the example, as illustrated in FIG. 4, the lateral side surface portion 30 is formed such that the end portion 30B at a joint portion to the first longitudinal side surface portion 32 protrudes in a bent shape. Specifically, the ridgeline 30A of the lateral side surface portion 30 is formed of a long side portion 30A1 extending obliquely with respect to the tire width direction W and a short side portion 30A3 inclined in a direction opposite to the long side portion 30A1 via a bent portion 30A2. Therefore, the lateral side surface portion 30 is provided with the end portion 30B of which the short side portion 30A3 is a ridgeline in a state of being protruded.

In the shoulder block 26, notches 56 and 56 are respectively provided at the central portions of the third longitudinal side surface portion 42 and the longitudinal side surface portion 38 facing the tire ground contact end E in the tire circumferential direction C. The notch 56 is a U-shaped recess in a plan view cut out from the block upper surface to a block bottom portion. The notches 56 are respectively provided at the central portions of the third longitudinal side surface portion 42 and the longitudinal side surface portion 38 in the ridgeline direction, that is, in the vicinity of the center of the ridgelines.

The shoulder block 26 is provided with a third sipe 58 of which one end opens into the notch 56 and the other end terminates within the shoulder block 26. The third sipe 58 is configured of two sipes extending in the tire width direction W, each one end opens into the notch 56 and the other ends terminate at positions at intervals each other in the tire width direction W. Therefore, a region in which a sipe is not present is secured at the central portion of the shoulder block 26.

The shoulder block 26 is further provided with fourth sipes 60 respectively on both sides of the third sipe 58 in the tire circumferential direction. In the example, in the fourth sipe 60, one end opens into the tire ground contact end E and the other end terminates within the shoulder block 26. The fourth sipes 60 are sipes extending in the tire width direction W and are respectively provided on the both sides of the third sipe 58 in the tire circumferential direction. The fourth sipe 60 extends from the tire ground contact end E toward an inside in the tire width direction W and terminates before reaching the shoulder main groove 18B beyond the center portion of the shoulder block 26 in the width direction.

In the example, although all the first, second, third, and fourth sipes 52, 54, 58, and 60 are the zigzag-shaped sipes which are bent at a plurality of places, the sipes may be linear sipes. In addition, the sipes 52, 54, 58, and 60 may not be necessarily parallel in the tire width direction W and may extend in the tire width direction W while being inclined as long as they extend in the tire width direction W. Groove widths of the sipes 52, 54, 58, and 60 are not particularly limited and, for example, may be 0.1 to 1.5 mm, may be 0.2 to 1.0 mm, or may be 0.3 to 0.8 mm.

A depth of the lateral groove 20 is not particularly limited and may be 30 to 80% of a depth of the main groove 18. Block rigidity can be easily secured and an effect of improving the uneven wear resistance property can be enhanced by making the depth of the lateral groove 20 shallow to 80% or less. In addition, a volume of the lateral groove is secured, an earth discharging property is improved, and an effect of improving the traction property can be enhanced by making the depth to 30% or more. As illustrated in FIG. 2, in the example, raised bridge portions 62, which connect respectively between the front and rear center blocks 24 and 24, and the front and rear shoulder blocks 26 and 26, are formed in the groove bottom of each of the lateral grooves 20A and 20B, and thereby the lateral groove 20 is formed shallower than the main groove 18.

As illustrated in FIG. 2, a plurality of protrusions 64 for preventing stone from biting are provided in the main grooves 18 at intervals in the tire circumferential direction C.

According to the embodiment described above, the longitudinal side surface portion 28 of the center block 24 is configured of the first longitudinal side surface portion 32 that is inclined with respect to the tire circumferential direction C and the second longitudinal side surface portion 34 that is inclined greater than the first longitudinal side surface portion 32 and of which the length is shorter than that of the first longitudinal side surface portion 32, and thereby it is possible to improve the traction property while maintaining the uneven wear resistance property.

In addition, in such a block shape, the notches 50 are provided in the pair of first longitudinal side surface portions 32 and thereby it is possible to increase traction elements and to improve the traction property. In addition, the notches 50 are provided at the central portion of the first longitudinal side surface portion 32 and thereby it is possible to eliminate a difference in the rigidity in each block 24 and to suppress uneven wear. In addition, the first sipe 52 connecting between the notches 50 and 50 on both sides is provided and thereby it is possible to further improve the traction property. Particularly, since the center block row 22A has a high ground contact pressure and a high traction effect, the first sipe 52 which opens into the notch 50 and connects between the notches 50 is provided in the center block 24, and thereby the effect of improving the traction property is excellent. In addition, the second sipes 54 are provided on both sides of the first sipe 52 in the tire circumferential direction and thereby it is possible to improve the traction property and to suppress uneven wear by equalizing the ground contact pressure within the center block 24. Furthermore, the second sipe 54 is a sipe of which the both ends terminate within the block. Therefore, it is possible to reduce the possibility of becoming a cause of block chipping and to improve the traction property while suppressing block chipping.

According to the embodiment, the second sipes 54, which are provided on the both sides of the first sipe 52, are configured of the sipes 54A extending parallel to the ridgeline 34A of the second longitudinal side surface portion 34 and the sipes 54B extending parallel to the ridgeline 30A of the lateral side surface portion 30. Therefore, the ground contact pressure within the center block 24 is further uniformized and thereby it is possible to further suppress the uneven wear.

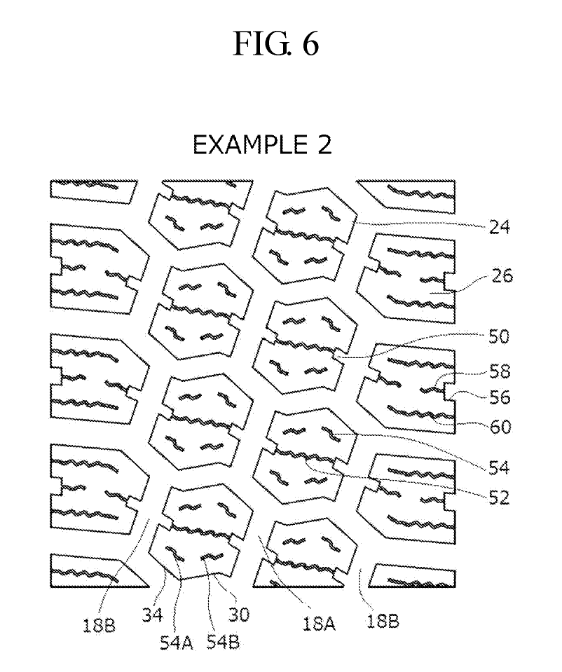

In addition, the length of the sipe 54B provided along the ridgeline 30A is set longer than the length of the sipe 54A provided along the ridgeline 34A corresponding to the ridgeline 30A of the lateral side surface portion 30 being longer than the ridgeline 34A of the second longitudinal side surface portion 34. Therefore, it is possible to further improve the traction property. As in another embodiment illustrated in FIG. 6, even if a length of a sipe 54A provided along a second longitudinal side surface portion 34 and a length of a sipe 54B provided along a lateral side surface portion 30 are set to the same length, it is possible to further uniformize the ground contact pressure within the block and to suppress the uneven wear.

In addition, the lateral side surface portion 30 of the center block 24 is formed such that one end portion 30B in the tire width direction W protrudes within the lateral groove 20A. Therefore, when the tire is driven, the protruding end portion 30B moves and thereby earth (mud) entering into the lateral groove 20A can be discharged and it is possible to improve the earth discharging property.

According to the embodiment, the longitudinal side surface portion 36 of the shoulder block 26 is configured of the third longitudinal side surface portion 42 inclined with respect to the tire circumferential direction C and the fourth longitudinal side surface portion 44 inclined greater than the third longitudinal side surface portion 42 and of which the length is shorter than that of the third longitudinal side surface portion 42. Therefore, it is possible to improve the traction property while maintaining the uneven wear resistance property. In addition, in the shoulder block 26, the notches 56 are provided at the right and left longitudinal side surface portions 36 and 38, and thereby it is possible to increase the traction elements and to improve the traction property. In addition, the notches 56 are provided at the central portions of the third longitudinal side surface portion 42 and the longitudinal side surface portion 38, and thereby it is possible to eliminate the difference in rigidity in each block 26 and to suppress the uneven wear.

In addition, in general, uneven wear is likely to occur in the shoulder block 26 where forces are input from the longitudinal direction (the tire circumferential direction) and the lateral direction (the tire width direction). According to the embodiment, in the shoulder block 26, a pair of notches 56 and 56 is not connected by a sipe and the third sipe 58 which is disconnected at the central portion of the block is provided. Therefore, it is possible to secure the block rigidity and to suppress occurrence of the uneven wear. In addition, the fourth sipes 60 are respectively provided on the both sides of the third sipe 58, and thereby the ground contact pressure within the shoulder block 26 is uniformized and it is possible to suppress the uneven wear.

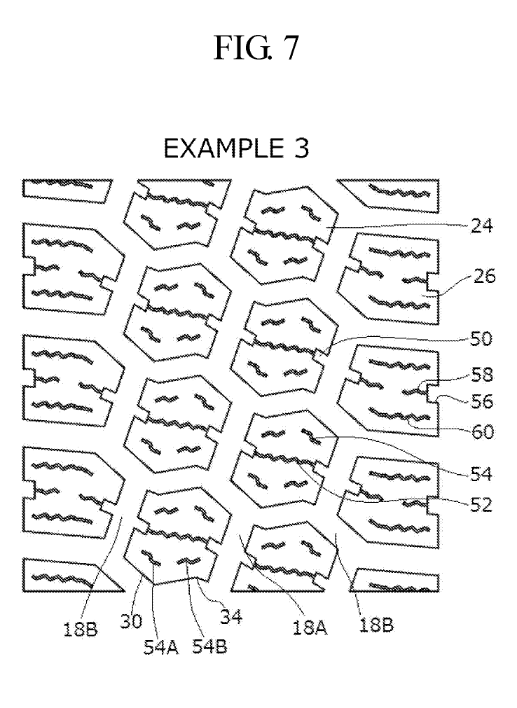

In addition, since a lateral force from the tire ground contact end E is input into the shoulder block 26, the fourth sipes 60 are formed so as to open into the tire ground contact end E. Therefore, it is possible to alleviate the lateral force and to improve the uneven wear resistance property. As in still another embodiment illustrated in FIG. 7, a fourth sipe 60 may be formed as a both-end closed sipe of which both ends terminate within a shoulder block 26. In this case, it is possible to uniformize the ground contact pressure within the block. Therefore, it is possible to suppress the uneven wear while securing the block rigidity.

In the embodiments described above, the number of the main grooves 18 is three, but the number of the main grooves is not particularly limited and, for example, may be four or five. It is preferable that the number of the main grooves is three or four. In addition, in the embodiments described above, the notches 50, and the first and second sipes 52 and 54 are provided in all the blocks 24 present in the center block row 22A, but may not be necessarily applied to all the blocks, and blocks having other configurations may be included in the blocks 24. Similarly, the notches 56, and the third and fourth sipes 58 and 60 may not be provided in all the blocks 26 present in the shoulder block row 22B, and blocks having other configurations may be included in the blocks 26.

The pneumatic tire according to the embodiment includes various vehicle tires such as a tire for a passenger car, a heavy duty tire of a truck, a bus, or a light truck (for example, an SUV vehicle or a pickup truck) or the like. In addition, applications such as a summer tire, a winter tire, and all-season tire are not particularly limited. It is preferable that the tire is the heavy duty tire.

Each dimension described above in the present specification is provided in a regular state with no load in which the pneumatic tire is mounted on a regular rim and is filled with air of a regular internal pressure. The regular rim is a “standard rim” in the JATMA standard, a “Design Rim” in the TRA standard, or a “Measuring Rim” in the ETRTO standard. The “regular internal pressure” is the “maximum air pressure” in the JATMA standard, the “maximum value” described in “TIRE LOAD LIMITS AT VARIOUS COLD INFLATION PRESSURES” in the TRA standard, or “INFLATION PRESSURE” in the ETRTO standard.

### Examples

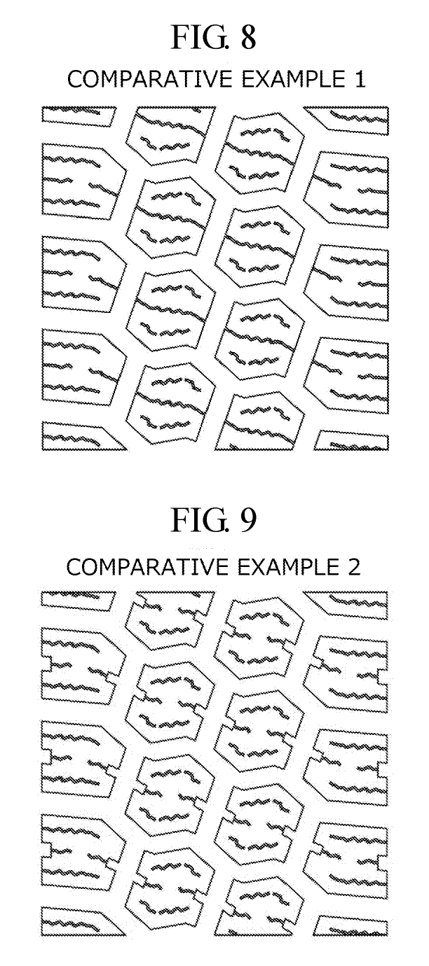

In order to confirm the above effects, a heavy duty pneumatic tire (tire size: 11R22.5) of Examples 1 to 3, and Comparative Examples 1 and 2 was mounted on rims of 22.5×7.50, filled with air of an internal pressure of 700 kPa, mounted on a vehicle with a constant loading capacity of 10 t, and evaluated for the traction property, the earth discharging property, and the uneven wear resistance property. The tire of Example 1 includes features of the embodiment illustrated in FIGS. 1 to 5 (groove width of the main groove=11.5 mm, the depth of the main groove=16.5 mm, α=20°, β=47°, θ=113°, and J1/J2=1.7). The tire of Example 2 has the tread pattern illustrated in FIG. 6. The tire of Example 3 has the tread pattern illustrated in FIG. 7. The tire of Comparative Example 1 has a tread pattern illustrated in FIG. 8. The tire of Comparative Example 2 has a tread pattern illustrated in FIG. 9. A difference in the tread pattern is as indicated in Table 1 and the configurations are the same except for the tread pattern.

Each evaluation method is as follows.

The traction property: an arrival time when advanced 20 m from a stop state on a road surface having a water depth of 1.0 mm was measured, and an inverse number of the arrival time was indexed with the value of Comparative Example 1 taking as 100. The larger the index, the shorter the arrival time and the better the traction property.

The earth discharging property (mud performance): an arrival time when advanced 20 m from a stop state on a muddy road was measured, and an inverse number of the arrival time was indexed with the value of Comparative Example 1 taking as 100. The larger the index, the shorter the arrival time and the better the earth discharging property.

The uneven wear resistance property: an uneven wear state (heel and toe wear amount) after traveling 20,000 km was measured and an inverse number of the heel and toe wear amount was indexed with the value of Comparative Example 1 taking as 100. The larger the index, the less occurrence of uneven wear and more excellent in the uneven wear resistance property.

TABLE 1

| | Comparative | Comparative | | | |
|---|---|---|---|---|---|
| | Example 1 | Example 2 | Example 1 | Example 2 | Example 3 |
| Tread pattern | FIG. 8 | FIG. 9 | FIG. 3 | FIG. 6 | FIG. 7 |
| Notch within | No | Yes | Yes | Yes | Yes |
| block | | | | | |
| First sipe of | Both ends open | One side closes | Both ends open | Both ends open | Both ends open |
| center block | | | | | |
| Second sipe of | Long and short | Long and short | Long and short | Same length | Same length |
| center block | | | | | |
| Fourth sipe of | Ground contact | Ground contact | Ground contact | Ground contact | Ground contact |
| shoulder block | end opens | end opens | end opens | end opens | end closes |
| Traction | 100 | 94 | 108 | 105 | 103 |
| property | | | | | |
| Earth | 100 | 102 | 102 | 102 | 102 |
| discharging | | | | | |
| property | | | | | |
| Uneven wear | 100 | 109 | 104 | 106 | 102 |
| resistance | | | | | |
| property | | | | | |

As a result, as indicated in Table 1, in Examples 1 to 3 in which the notches are provided, improvement effects were obtained in all the traction property, the uneven wear resistance property, and the earth discharging property compared to Comparative Example 1 in which the notches are not provided in the center block and the shoulder block. In Example 2 in which the fourth sipes are opened to the ground contact end side, the improvement effects were obtained in the traction property and the uneven wear resistance property compared to Example 3 in which the both ends of the fourth sipes of the shoulder block are closed. In addition, in Example 1 which has the second sipes having long and short lengths and the sipes having a long length along the lateral side surface portion of the center block are provided, the improvement effects were further obtained in the traction property compared to Example 2. On the other hand, in Comparative Example 2, since the first sipe of the center block is closed at one side and does not connect the notches on both sides, although the uneven wear resistance property was improved, the traction property was greatly deteriorated.

While several embodiments are described above, these embodiments are presented by way of example and are not intended to limit the scope of the invention. These novel embodiments can be implemented in various other forms, and various omissions, substitutions, and changes can be made without departing from the spirit of the invention.

What is claimed is:

1. A pneumatic tire comprising:
a tread portion which is provided with a plurality of main grooves extending in a tire circumferential direction, and a plurality of lateral grooves extending in a direction intersecting the main grooves, to form block rows,
wherein at least one block row sandwiched between the main grooves includes blocks having a pair of longitudinal side surface portions facing the main grooves and a pair of lateral side surface portions facing the lateral grooves, in which the pair of longitudinal side surface portions includes a pair of first longitudinal side surface portions that has ridgelines inclined with respect to the tire circumferential direction, and a pair of second longitudinal side surface portions that has ridgelines shorter than the ridgelines of the first longitudinal side surface portions and inclined greater with respect to the tire circumferential direction than the ridgelines of the first longitudinal side surface portions, and intersects the first longitudinal side surface portions at an obtuse angle, and
wherein the block comprises notches formed at central portions of the pair of first longitudinal side surface portions, a first sipe that is opened to the notches and connects the notches on both sides, and second sipes formed on both sides of the first sipe in the tire circumferential direction and having both ends thereof terminated within the block.

2. The pneumatic tire according to claim 1,
wherein the second sipe includes a sipe extending parallel to the ridgeline of the second longitudinal side surface portion and a sipe extending parallel to the ridgeline of the lateral side surface portion.

3. The pneumatic tire according to claim 2,
wherein a length of the sipe extending parallel to the ridgeline of the lateral side surface portion is greater than a length of the sipe extending parallel to the ridgeline of the second longitudinal side surface portion.

4. The pneumatic tire according to claim 1,
wherein the lateral side surface portion is formed such that one end portion in a tire width direction protrudes into the lateral groove.

5. The pneumatic tire according to claim 1,
wherein the block row is a center block row that is positioned at a central portion of a tread portion in the tire width direction.

6. The pneumatic tire according to claim 5,
wherein an end portion of the tread portion in the tire width direction includes a shoulder block row sandwiched between the main groove extending the tire circumferential direction and a tire ground contact end,
wherein the shoulder block row includes shoulder blocks having a longitudinal side surface portion facing the main groove, in which the longitudinal side surface portion includes a third longitudinal side surface portion that has ridgeline inclined with respect to the tire circumferential direction, and a fourth longitudinal side surface portion that has ridgeline shorter than the ridgeline of the third longitudinal side surface portion and inclined greater with respect to the tire circumferential direction than ridgeline of the third longitudinal side surface portion, and intersects the third longitudinal side surface portion at an obtuse angle, and
wherein the shoulder block comprises notches formed at a central portion of the third longitudinal side surface portion and at a central portion of a longitudinal side surface portion facing the tire ground contact end.

7. The pneumatic tire according to claim 6,
wherein the shoulder block comprises a third sipe of which one end is opened to the notch and the other end terminates within the shoulder block, and fourth sipes formed on both sides of the third sipe in the tire circumferential direction.

8. The pneumatic tire according to claim 7,
wherein the fourth sipes are formed such that one end is opened to the tire ground contact end and the other end terminates within the shoulder block.
